(19) United States
(12) Patent Application Publication
(10) Pub. No.: US 2015/0092410 A1
(43) Pub. Date: Apr. 2, 2015

(54) LUMINAIRE

(71) Applicant: LSI Industries, Inc., Cincinnati, OH (US)

(72) Inventors: John D. Boyer, Lebanon, OH (US); David Lonneman, Pleasant Plain, OH (US); Daniel Hutchens, Cold Springs, KY (US); Eric Jon Mooar, Liberty Township, OH (US); Travis Montgomery Wright, Cincinnati, OH (US); Andrew J. Bankemper, California, KY (US)

(21) Appl. No.: 14/294,445

(22) Filed: Jun. 3, 2014

Related U.S. Application Data
(60) Provisional application No. 61/883,681, filed on Sep. 27, 2013.

(51) Int. Cl. F21K 99/00; F21V 5/04; F21V 29/00

(52) U.S. Cl. CPC F21K 9/30; F21V 29/2212; F21V 5/04; F21Y 2101/02
USPC 362/235; 362/249.01; 362/249.02; 362/311.01; 362/362; 362/373

(57) ABSTRACT

A luminaire is disclosed having a lighting element mount which can have a base and one or more wings acting has heat dissipation fins. A lighting element (e.g. a PCB populated with LEDs) can be mounted (e.g. directly) to the base of the lighting element mount to conduct heat away from the lighting element. The lighting element mount can be incorporated into the luminaire so as to associate the lighting elements with apertures in the luminaire, thus allowing the lighting elements to be protrude to the bottom of the luminaire while the wings extend rearward of the luminaire and both the base and the wings of the lighting element mount are exposed to ambient air.

### FIELD OF THE DISCLOSURE

The present disclosure is directed generally to a luminaire having lighting elements mounted to heat sinks for removing heat from the lighting elements. The present disclosure finds particular application to use of LEDs and placement of one or more printed circuit boards (“PCB”) comprising light emitting diodes (“LED”) on the heat sinks to remove heat from the PCB.

### BACKGROUND OF THE DISCLOSURE

There is a need for a luminaire of the type described herein. More particularly, LEDs can be driven to provide light more efficiently than other light sources such as incandescent or fluorescent lighting. This efficiency stems from the ability to provide the same lumens for less power consumption. This efficient also stems from the longevity of LEDs, which can last 10,000 to 20,000 hours before failure. However, it is believed that both of these efficiencies are deteriorated by exposing the LEDs to excess heat. The configuration of the luminaire of the present disclosure removes heat from the LEDs and any associated PCB to maximize efficiencies of the LEDs.

### SUMMARY OF THE DISCLOSURE

A luminaire is disclosed comprising a housing containing a driver, a wing extending from the housing and defining an aperture, a lighting element mount, the lighting element mount comprising a face defining two opposing edges, and a wing extending from each opposing edge, the luminaire further comprising a lighting element mounted to the face of the lighting element mount, the lighting element mount associated with the wing such that the lighting element is aligned over the wing apertures. The housing may define one or more slots and the wing having one or more tabs associated with the one or more slots of the housing. The wing may have a flat mounting plate in which the apertures are defined, and a lens flange extending downward from the mounting plate, the lens flange then directed inward toward the housing such that the mounting plate and the lens flange together define a channel open toward the housing, and a lens residing in the channel. The face and wings of the lighting element mount may define a U-shape. The lighting element may be thermally connected to the lighting element mount face and the wings of the lighting element mount may be exposed to ambient air to facilitate heat dissipation. A mounting tab may extend from the end of the lighting element mount face, the mounting tab being secured to the wing adjacent to the aperture. The lighting element may comprise one or more LEDs. The lighting element may comprise a PCB populated with one or more LEDs. Two lighting element mounts may be secured to the wing.

The present disclosure discloses a luminaire comprising a housing having a base, a first leg extending from one edge of the base and a second leg extending from an opposing edge of the base, the housing defining a U-shape, a first wing extending from the housing and defining a first aperture, a first lighting element mount, the first lighting element mount comprising a face defining two opposing edges, and a wing extending from each opposing edge, a first lighting element mounted to the face of the first lighting element mount, the first lighting element mount associated with the first wing such that the lighting element is aligned over first the wing apertures, the luminaire further comprising a second wing extending from the housing on a side opposing the first wing, the second wing defining a second aperture, a second lighting element mount, the second lighting element mount comprising a face defining two opposing edges, and a wing extending from each opposing edge, a second lighting element mounted to the face of the second lighting element mount, the second lighting element mount associated with the second wing such that the lighting element is aligned over second the wing apertures, the luminaire further comprising a driver for delivering power to the first and second lighting elements, the driver located in the U-shaped housing. The housing defining a plurality of slots and the first wing having one or more tabs associated with one or more of the plurality of slots of the housing, the second wing having one or more tabs associated one or more of the plurality of slots of the housing. The first wing having a flat mounting plate in which the first aperture is defined, and a lens flange extending downward from the mounting plate, the lens flange then directed inward toward the housing such that the mounting plate and the lens flange together define a channel open toward the housing, and a lens residing in the channel. The face and wings of the first lighting element mount defining a U-shape. The first lighting element thermally connected to the first lighting element mount face and the wings of the first lighting element mount exposed to ambient air to facilitate heat dissipation. A mounting tab extending from the end of the first lighting element mount face, the mounting tab secured to the first wing adjacent to the aperture. The first lighting element comprises one or more LEDs. The first lighting element comprises a PCB populated with one or more LEDs.

The present disclosure further discloses a luminaire comprising a housing containing a driver, a mounting plate defining an aperture, a lighting element mount, the lighting element mount comprising a face defining two opposing edges, a wing extending from each opposing edge, and a mounting tab extending from the end of the first lighting element mount face, the luminaire further comprising a lighting element mounted to the face of the lighting element mount, and the mounting tab secured to the mounting plate adjacent to the aperture such that the lighting element is aligned over the wing apertures. The face and wings of the first lighting element mount may define a U-shape. The lighting element may be thermally connected to the first lighting element mount face and the wings of the first lighting element mount may be exposed to ambient air to facilitate heat dissipation. The lighting element may comprise one or more LEDs. The lighting element may comprise a PCB populated with one or more LEDs.

### BRIEF DESCRIPTION OF THE DRAWINGS

Aspects and embodiments of the present disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1A is a top-side perspective view of a luminaire in accordance with the present disclosure;

FIG. 1B is a bottom-side perspective view of the luminaire depicted in FIG. 1A;

FIG. 2 is a partially exploded view of the luminaire depicted in FIG. 1A;

FIG. 3A is a cross-sectional view of the luminaire depicted in FIG. 1A taken at 3B-3B;

FIG. 3B is a partially exploded view of the cross-sectional view of FIG. 3A;

FIG. 4 is a perspective view of a housing of the luminaire of FIG. 1A;

FIG. 5 is a perspective view of a wing of the luminaire of FIG. 1A;

FIG. 6 is a perspective view of a lighting element mount of the luminaire of FIG. 1A;

FIG. 7A is a bottom-side perspective view of one embodiment of design features of the luminaire depicted in FIG. 1A;

FIG. 7B is a top-side perspective view of design features of the luminaire depicted in FIG. 1A;

FIG. 7C is a bottom view of the design features of the luminaire depicted in FIG. 1A;

FIG. 7D is a top view of the design features of the luminaire depicted in FIG. 1A;

FIG. 7E is a left-side view of the design features of the luminaire depicted in FIG. 1A, the right-side view being the same; and

FIG. 7F is a front view of the design features of the luminaire depicted in FIG. 1A, the rear view being the same.

The embodiments depicted in the drawing are merely illustrative. Variations of the embodiments shown in the drawings, including embodiments described herein, but not depicted in the drawings, may be envisioned and practiced within the scope of the present disclosure.

### DETAILED DESCRIPTION

Aspects and embodiments of the present disclosure provide a luminaire 100 and elements thereof. The figures depict a luminaire 100, in accordance with the present disclosure, having a housing 102 extending along a longitudinal axis 104 and a first housing wing 106a extending from one side of the housing 102 and a second housing wing 106b extending from an opposing side of the housing 102. Each housing wing 106 comprises lighting elements 108 mounted to lighting element mounts 110 and an optional insulator 112 over the lighting elements 108. A lens 114 is secured to each housing wing 106 to protect the lighting elements 108 and or to manage the direction or diffusion of the light emitted from the lighting elements 108. A housing cover 116 is secured to the bottom of the housing 102 and a pair of end covers 118a, 118b are secured to opposing longitudinal ends of the housing 102 to enclose a driver 120 within the housing 102. The driver 120 provides and manages power to the lighting elements 108 to control their illumination.

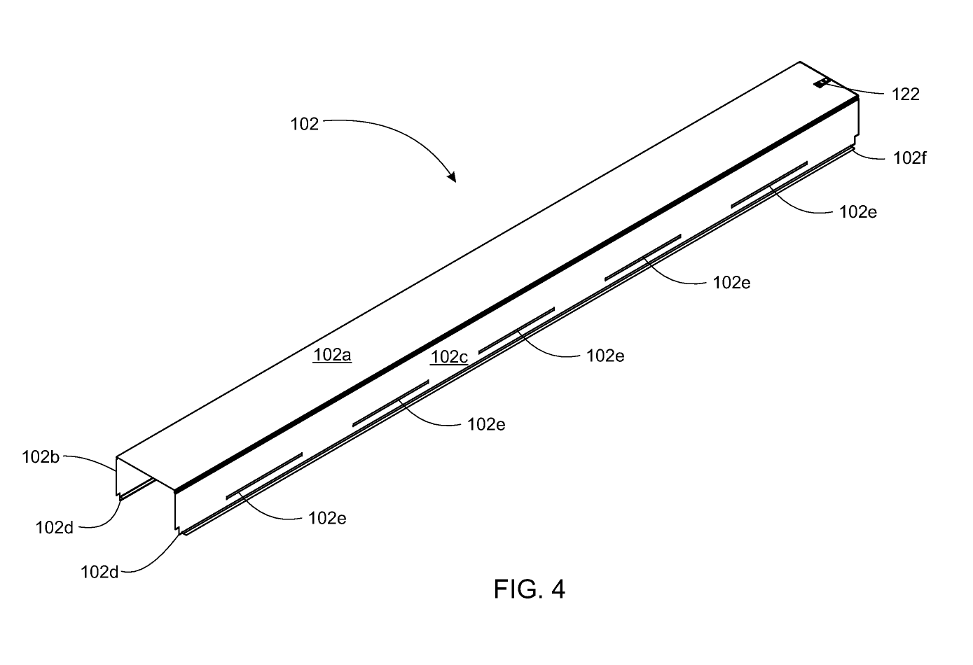

As depicted in FIG. 4, the housing 102 defines an inverted U-shape having a base 102a at the top with a first leg 102b and a second leg 102c extending downward from opposing lateral sides of the base to a distal end 102d. In the depicted preferred embodiment, the first and second legs 102b, 102c each extend perpendicular to the base 102a. The first and second legs 102b, 102c each comprise a series of slots 102e running parallel to the longitudinal axis of the luminaire 100 near the distal end of the first and second legs 102b, 102c. Alternatively, a single slot running the length covered by the combined slots 102e to provide a similar function, as will be understood in light of the function of the slot as described below. A lens flange 102f extends outward from the distal end 102d of each leg to hold the corresponding lens 114, as shown and described herein. In the depicted preferred embodiment the lens flange 102f extends perpendicular to the corresponding first or second leg 102b, 102c. Although each of the base 102a and the first and second legs 102b, 102c are depicted as straight, other embodiments are contemplated as facilitating the functionality described herein. In the depicted embodiment, the housing 102 runs the entire length of the luminaire 102, but other configurations are contemplated.

The driver 120 is depicted as secured to the base 102a of the housing. This keeps the driver 120 as far from the lighting elements 108 as possible in order to distance the heat generated by the driver 120 from the lighting elements 108. However, the driver 120 can be located in other locations, including external of the housing 102 and/or the luminaire 100 generally. The driver 120 can be any commercially available driver appropriate for providing power to the chosen lighting elements 108 as necessary to provide the desired output of lumens. The driver 120 can optionally be thermally insulated from the housing 102.

The first wing 106a and second wing 106b are identical to one another in construction, but rotated to be mirror images of one another in the final assembled configuration, as depicted in the figures. The configuration of the first wing 106a will therefore be described, with the understanding that the second wing 106b is of identical (although depicted as mirror) construction. Although the identical construction of the first and second wings 106a, 106b reduces the total number of different parts needed for construction of the luminaire 100, many of the benefits of the luminaire 100 described herein can be obtained by providing first and second wings 106a, 106b having constructions different from one another.

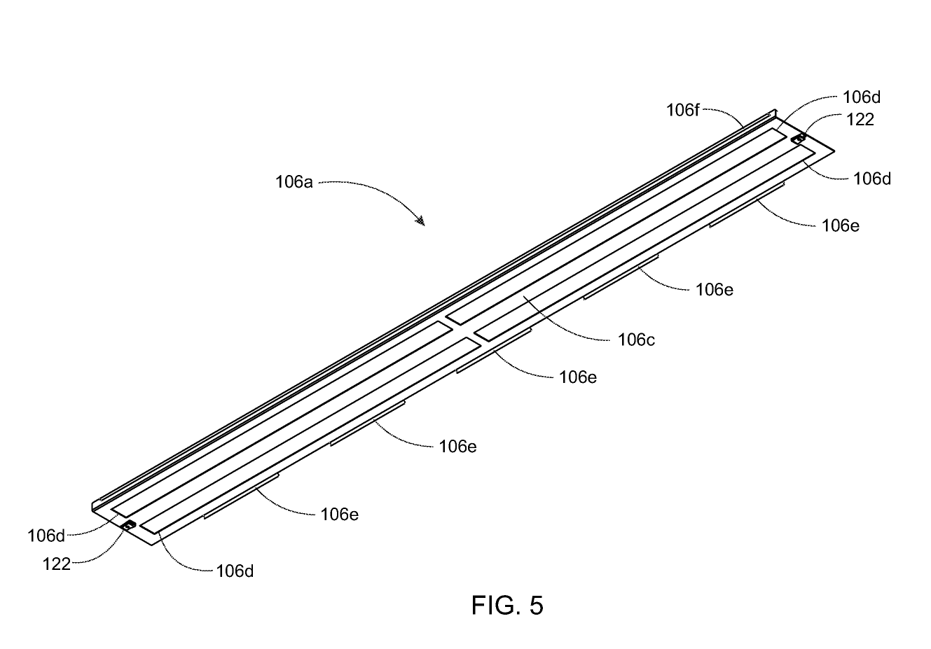

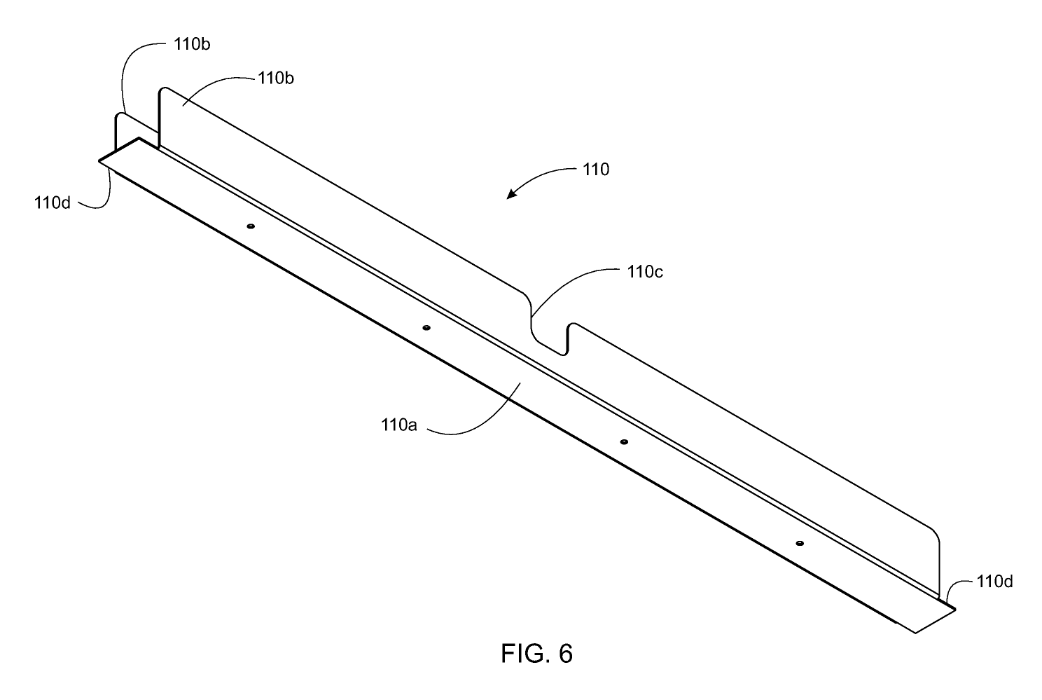

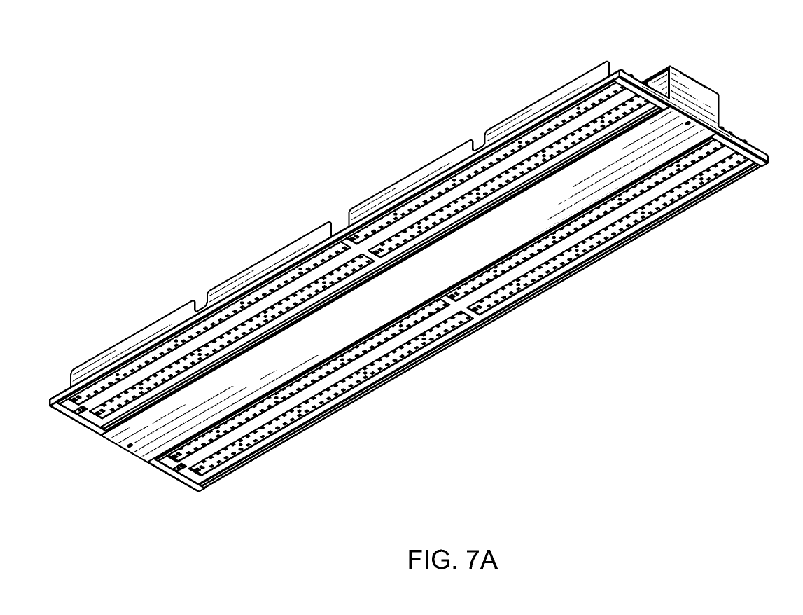

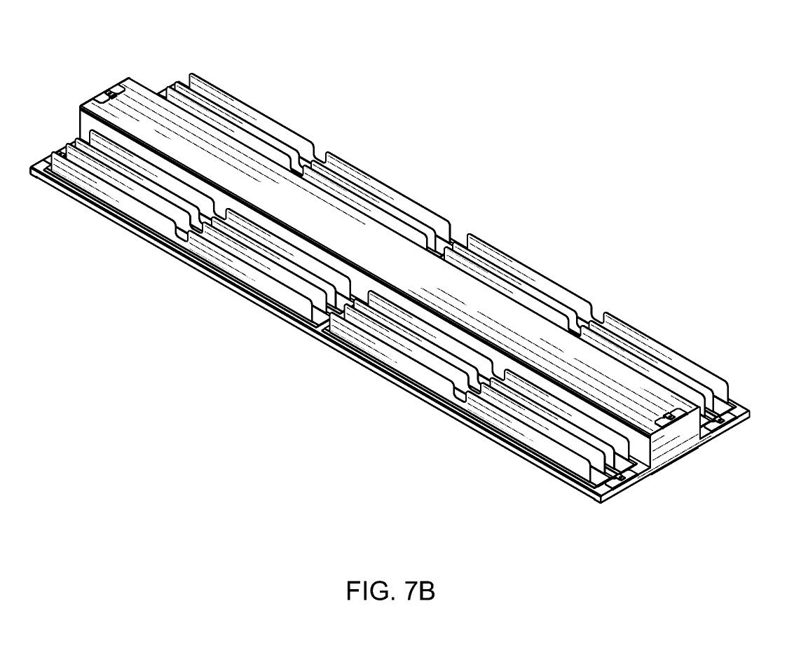

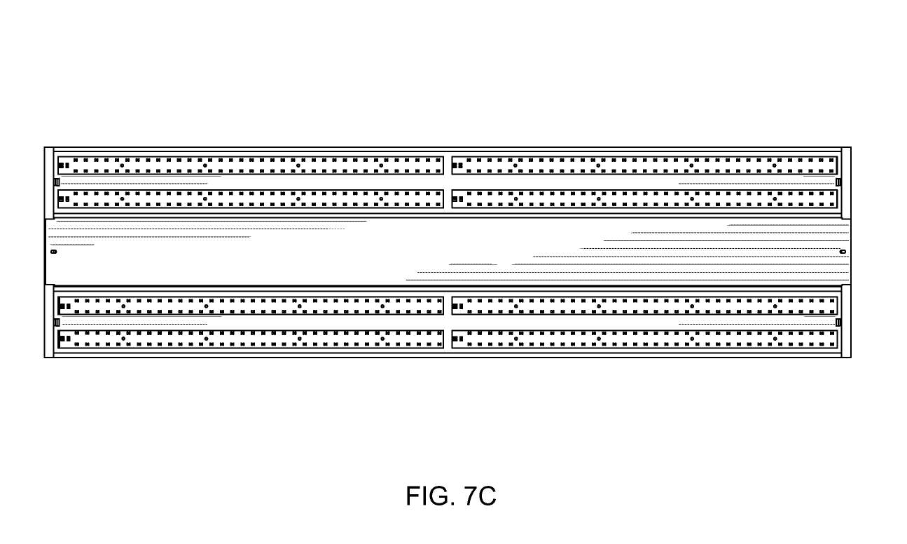

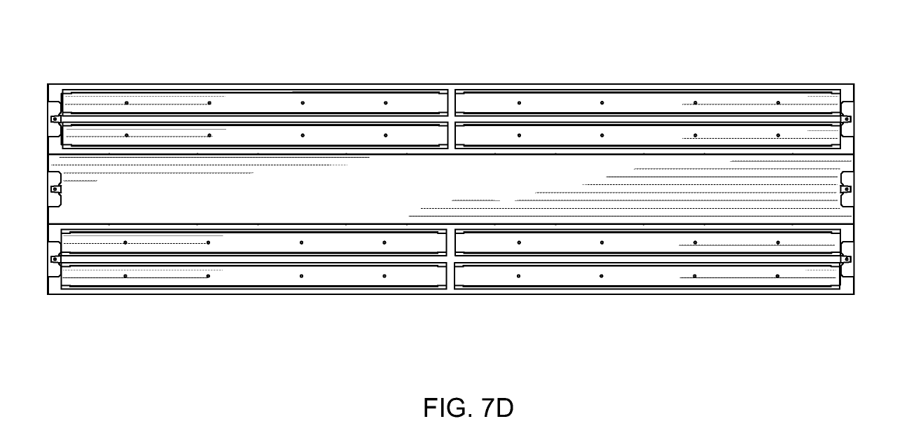

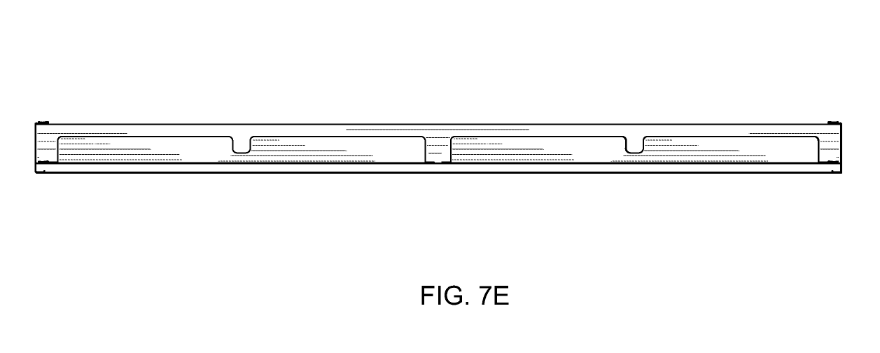

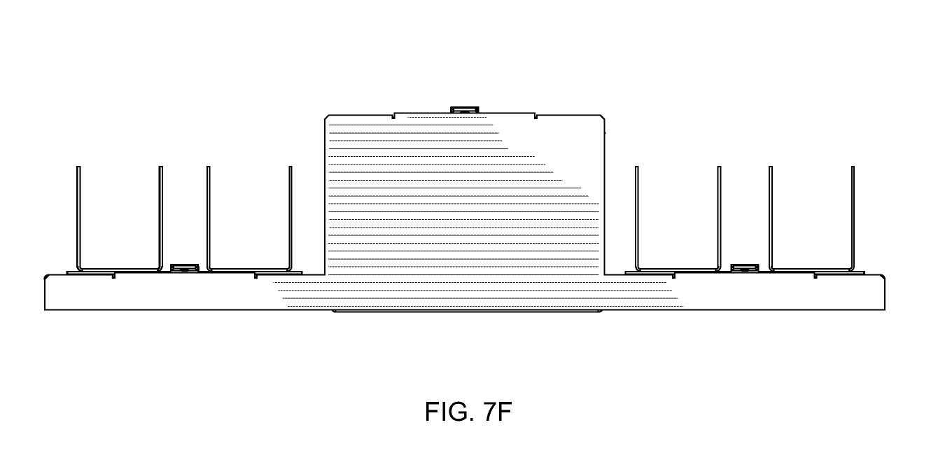

As depicted in FIG. 5, the first wing 106a comprises a mounting plate 106c that is flat in the depicted embodiment defines a plane as well as four apertures 106d. The apertures 106d define elongated rectangles to match the outer perimeter of the lighting elements 108 described below, but other configurations are contemplated to match the perimeter of the lighting elements and allow light to pass through the apertures 106d. A series of tabs 106e extend from the longitudinal edge of the mounting plate 106c that is positioned proximate to the housing 102. The tabs 106e extend upward, perpendicular to the plane defined by the mounting plate 106c. The tabs 106e reside in the housing slots 102e as depicted with the upwardly extending portion of the tabs 106e rest against the inside of the housing leg 102a to hold the wing 106a to the housing 102. In the depicted embodiment, the first wing 106a comprises the same number of tabs 106e as the housing comprises slots 102e on the associated one of the first and second housing legs 102a, 102b. The tabs 106e extend a short distance from the longitudinal edge of the mounting plate 106c, but a sufficient distance such that once the wing 106a is assembled with the housing 102, as described above, the tabs 106e will extend sufficiently beyond the slots 102e to hold the wing 106a to the housing 102.

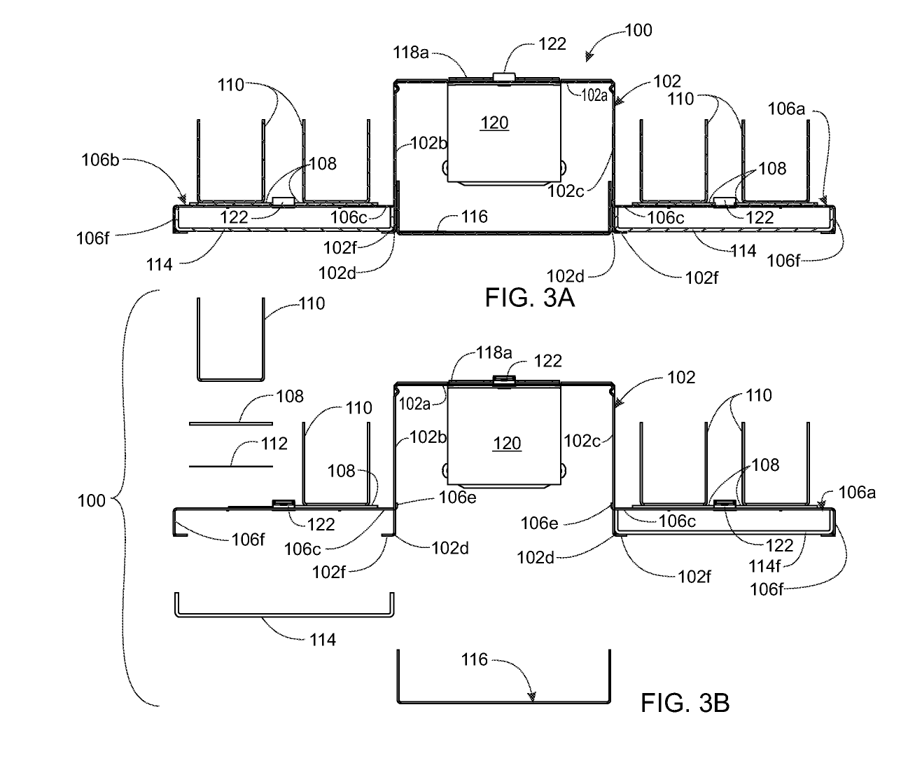

A lens flange 106f extends downward from the distal edge of the mounting plate 106c, perpendicular thereto and then inward toward the housing 102 such that the mounting plate 106c and the lens flange 106f together define a channel. When the wing 102a is mounted to the housing, this channel is open toward the housing 102 such that the wing lens flange 106f and the housing lens flange 102f together form a frame to hold the lens 114 as shown for example, in FIGS. 3A and 3B. The lens 114 may be inserted between the wing 106a and the housing 102 after the wing tabs 106e have been inserted into the housing tabs 102e and the wing 106a is being rotated downward toward the housing. One manner of assembling the wing 106a to the housing 102 comprises: (a) rotating the mounting plate 106c to be at an angle to the associated one of the first and second housing legs 102a, 102b, (b) locating the wing tabs 106e in the slots 102e of the associated one of the first and second housing legs 102a, 102b, (c) inserting the wing tabs 106e into the slots 102e, (d) until the base of the wing tabs 106e reach the slots 102e and then rotating the wing mounting plate 106c toward perpendicular with the associated one of the first and second housing legs 102a, 102b while continuing to insert the wing tabs 106e, (e) inserting the lens 114 into the wing 106a, and (f) continuing to rotate the wing mounting plate 106c until the lens 114 contacts the housing 102 to stop rotation and downward pull of gravity causes the wing 106a to rest in the housing 102 as depicted in FIGS. 3A and 3B. The lens 114 will then rest on the housing lens flange 102f and the wing lens flange 106f. Additional securing structure may be added to further secure the wings 106a, 106b to the housing 102. In the optional embodiment in which the lens 114 is not employed, the tabs 106e inserted in slots 106e are sufficient to hold the wings 106a, 106b to the housing 102.

The lighting element mount 110 is comprised of a face 110a and two wings 110b extending from either lateral edge of the face 110a to define an elongated U-shape with the face 110a as a base of the U and the wings 110b as the legs of the U. Each wing 110b defines a cutout 110c approximately mid-way along its length. The cutout 110c may be removed (i.e. filled in) or of different size and/or shape. The face 110a receives the lighting element 108. In the depicted embodiment, the lighting element 108 is a flat printed circuit board (“PCB”) populated with LEDs and the face 110a of the lighting element mount 110 is planar to receive the flat PCB. The PCB is mounted to the face 110a in any known manner to provide for thermal conduction between the PCB and the face 110a so that the lighting element mount 110 will act as a heat sink for the heat generated by the LEDs of the lighting element 108. The PCB can be mounted directly to the lighting element mount 110 to provide heat conducting contact there between and maximize heat flow from the PCBs. Heat conducting compounds or structures may optionally be inserted between the lighting element mount 110 and the PCB to increase contact, and thus heat transfer, there between. Other shapes of alternative lighting elements 108, including non-flat PCBs, are contemplated and may be accommodated by a corresponding, non-flat face 110a.

The wings 110b act as heat dissipation fins to increase the surface area of the lighting element mounts 108 and to project away from the wing to take advantage of upward heat currents and to elevate into ambient air currents to increase convection and radiation. The height and length of fins required to provide a sufficiently rate of heat dissipate will depend on the LEDs and the power provided to them and will be readily calculable by those skilled in the art.

The lighting element mounts 110 comprise a mounting tab 110d extending from the face 110 at each longitudinal end. The mounting tabs 110d extend beyond the extremities of the wing apertures 106d so the LEDs of the PCB are located in the wing aperture 106d and the mounting tabs 110d extend beyond the wing aperture 106d to hold the lighting element mount 110 from falling through the wing aperture 106d. In the depicted embodiment, the wing aperture 106d approximates the size of the PCB so that the PCB approximately fills the wing aperture 106d and projects through the wing aperture 106d. In the depicted embodiment, the light emitted by the LEDs is not redirected by reflectors or optics. It is contemplated that reflectors or optics may be used with the luminaire 100 to provide a particular light distribution. The lighting element mount 110 is preferably mounted to the associated wing 106a, 106b by securing the mounting tab 110d to the wing mounting plate 106b by any known means, such as welding or the like, or screws or the like, etc. The connection between the mounting tab 110d and the wing mounting plate 106b also causes the entire wing 106a, 106b to act as a heat sink and dissipate heat from the PCBs. Alternatively, the width of the lighting element mount face 110a may be wider than the associated wing aperture 106d so that portions of the lighting element mount face 110a rest on the lateral sides of the wing aperture 106 to transmit heat to the wing 106a, 106b. The wings 106a, 106b are depicted as having four apertures 106d, each associated with a separate lighting element mount 110, which is each associated with a single lighting element 108 (depicted as a PCB). Other configurations are contemplated, without departing from this disclosure, such as doubling the length of the lighting element mounts 110 to accommodate two PCBs each, doubling the width of the lighting element mounts 110 to accommodate two PCBs each, or making a single lighting element mount 110 to cover all four wing apertures 106d and accommodate all four PCBs.

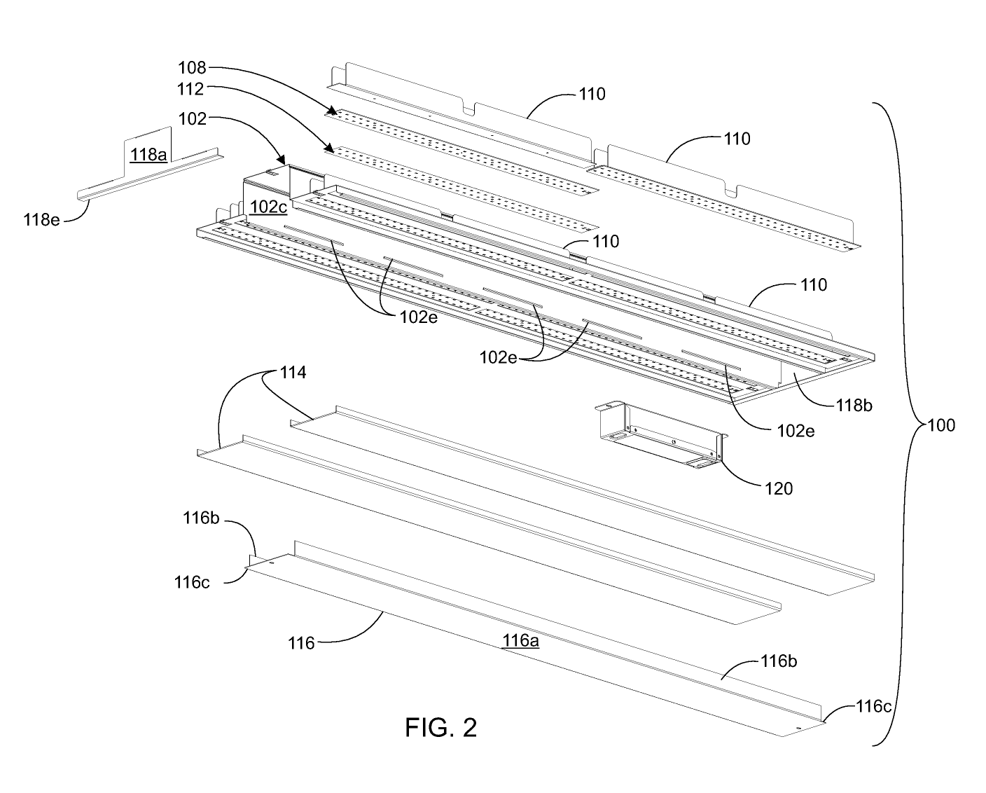

Optionally, a dielectric paper 112 covers the PCB, as shown in FIG. 2. Other dielectrics or no dielectric are also contemplated.

In the depicted embodiment, the luminaire 100 is configured to have two rows of lighting elements 108, and associated lighting element mounts 110, in each wing 106. Each row is comprised of two lighting element mounts 110 and associated lighting elements 108. The luminaire can be comprises of one such row of lighting elements 108, and associated lighting element mounts 110, in a smaller wing or the same size wing. The luminaire could also be comprised of three, four or more rows of lighting elements 108, and associated lighting element mounts 110, as needed to provide the appropriate number of lighting elements 108 to allow the luminaire to provide the desired lumens. Additional rows of lighting elements 108 and associated lighting element mounts 110 could be fit into the existing wing 106 or by widening the mounting plate 106c to accommodate additional apertures 106d, lighting elements 108 and lighting element mounts 110. Additionally, each row can be comprised of one lighting element 108 and one lighting element mount 110, the two lighting elements 108 and associated lighting element mounts 110 shown, or more than two lighting elements 108 and associated lighting element mounts 110. Further, each lighting element mount 110 can be associated with more than one lighting element 108. For example, the lighting element mount 110 could run the entire length of the row in the depicted embodiment and be associated with the two lighting elements 108 shown.

In one embodiment, the lighting elements 108 may be assembled with the lighting element mounts 110 as subassemblies, with the dielectric 112 if used. In this manner, these subassemblies may be ready for installation in a luminaire 100 or variations thereof having greater or fewer rows of lighting elements 108.

In another embodiment, one or more of the lighting elements 108 may be assembled with the lighting element mounts 110, with the dielectric 112 if used, and mounted to the wing 106 as subassemblies. In this manner, these subassemblies may be ready for installation to a ready housing 102.

Optionally, the luminaire 100 comprises one lens 114 in each wing 106a, 106b, as best depicted in FIGS. 3A and 3B. The lens 114 may be simply to protect the lighting elements 108 or may also impart direction to the light rays emitted from the lighting element 108 to provide a desired light distribution. As described above, the lens 114 may be inserted above the housing lens flange 102f and the wing lens flange 106f during assembly of the wing 106a, 106b to the housing 102. Alternatively, the lens 114 may be slide into location after the wing 106 is assembled to the housing 102.

The housing cover 116 comprises a base 116a and two legs 116b extending from opposing sides of the base 116a to define U-shape. A mounting flange 116c extends from each end of the base 116a and beyond the legs 116b. The base 116a and legs 116b are approximately the same length as the housing 102. The housing cover base 116a is approximately the width of the housing base 102a such inserting the housing cover legs 116b into the bottom of the housing will cause the housing cover legs 116b to encounter the housing first and second legs 102a, 102b. Preferably, the housing cover legs 116b encounter the wing tabs 106e that protrude through the housing slots 102e and deflect the housing cover legs 116b inward, causing enough of a force fit to temporarily hold the housing cover 116 to the housing 102.

Each end cover 118a, 118b comprises a central plate 118c and a pair of wing plates 118d extending from opposing sides of the central plate 118c. The central plate 118c covers the end of the housing 102 and the wing plates 118d cover the area created by the wing 106 and the lens 114. The end covers 118a and 118b are applied to opposing ends of the housing 102 and secured thereto by any known means. Tab and prong connectors 122 are shown at the housing base 102a and wing mounting plates 106c. A holding flange 118e extends longitudinally inward from the bottom of the end cover central plate 118c and the end cover wing plates 118d. The holding flange 118e of the two end covers 118a, 118b hold the wings 106 secure and, preferably, stationary, and prevent the housing covers 116 from falling out of the housing 102.

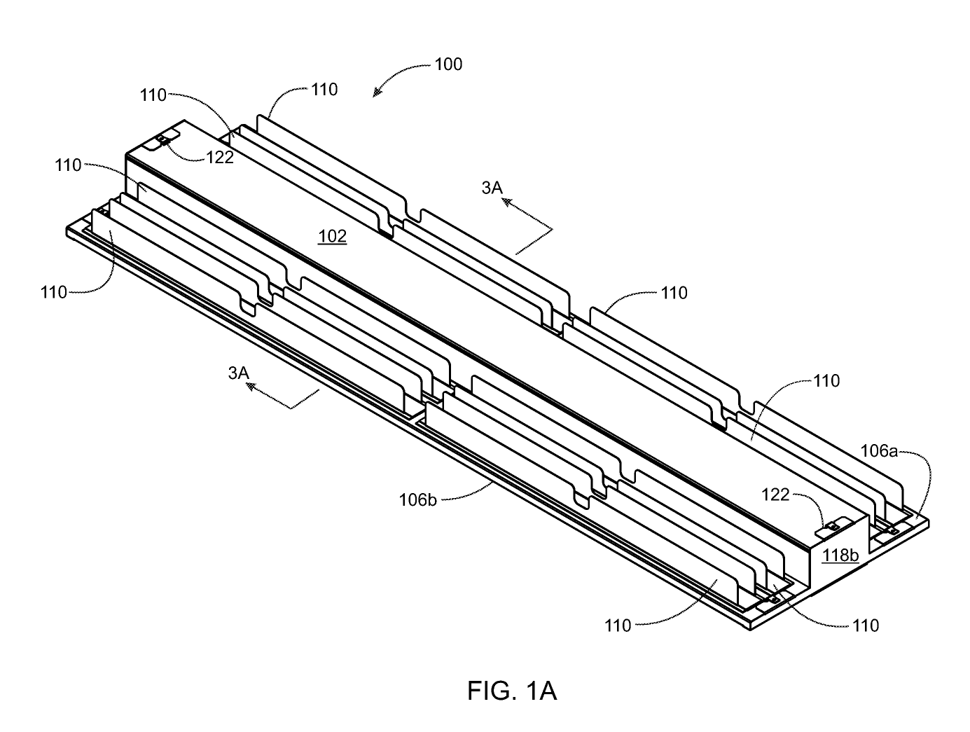

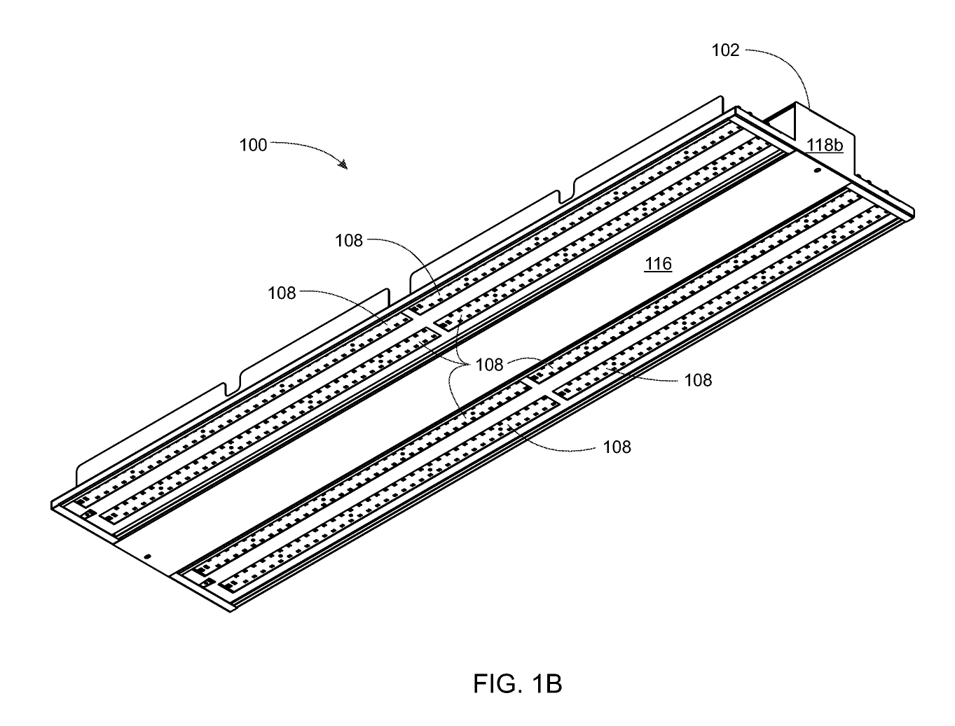

As best depicted in FIGS. 1A, 1B, 3A and 3B, the rear of the wings 106a, 106b are not enclosed by a housing or other structure. This leaves the lighting element mount wings 110 as well as the rear of the lighting element mount face 110a directly exposed to ambient air. This provides a significant amount of surface area for dissipation and radiation. Moreover, the rear of the lighting element mount face 110a is immediately proximate to the lighting elements 108, which are the major heat sources in the case of LEDs. This provides a direct and prompt route for the heat to be pulled from the lighting elements 108 and expelled from the luminaire 100. If no lens 114 is used, then the front face of the lighting elements 108 are also directly exposed to ambient air, further contributing to the cooling of the lighting elements 108.

It will be readily apparent to those skilled in the art how to run electrical wiring to the driver 120 and from the driver to the one or more lighting elements 108.

Any one or more of the housing 102, wings 106, lighting element mount 110, end cover 118 and/or housing cover 116 is preferably constructed of sheet metal formed by known methods. Alternatively, any one or more of the housing 102, wings 106, lighting element mount 110, end cover 118 and/or housing cover 116 can formed from any other known material or method including cast metal or molded polymers.

While the luminaire 100 depicted in the figures is generally applicable to any application that would benefit from indoor or outdoor area lighting, it is well-suited, in one example, for application to high bay applications such as warehouses and the like. The luminaire 100 can be mounted directly to a structure, such as a ceiling, or hung from the structure using standard mounting hardware according to standard methods. In the depicted configuration, the luminaire 100 is preferably mounted by securing the housing 102 to the structure rather than the wings 106a, 106b because downward gravity on the wings 106a, 106b assists in the attachment of the wings 106a, 106b to the housing 102, as described above. However, the wings 106a, 106b could be secured to the structure, in addition to or exclusive of the housing 102, if the wings 106a, 106b were secured to the housing 102 in a different manner or in additional manners to the manner described above.

While the preferred embodiment uses light emitting diodes (“LEDs”) as light sources, other light sources may be used in addition to LEDs or instead of LEDs within the scope of the present disclosure. By way of example only, other light sources such as plasma light sources may be used. Further, the term “LEDs” is intended to refer to all types of light emitting diodes including organic light emitting diodes or “OLEDs”. The LEDs of this exemplary embodiment can be of any kind, color (e.g., emitting any color or white light or mixture of colors and white light as the intended lighting arrangement requires) and luminance capacity or intensity, preferably in the visible spectrum. Color selection can be made as the intended lighting arrangement requires. In accordance with the present disclosure, LEDs can comprise any semiconductor configuration and material or combination (alloy) that produce the intended array of color or colors. The LEDs can have a refractive optic built-in with the LED or placed over the LED, or no refractive optic; and can alternatively, or also, have a surrounding reflector, e.g., that re-directs low-angle and mid-angle LED light outwardly. In one suitable embodiment, the LEDs are white LEDs each comprising a gallium nitride (GaN)-based light emitting semiconductor device coupled to a coating containing one or more phosphors. The GaN-based semiconductor device can emit light in the blue and/or ultraviolet range, and excites the phosphor coating to produce longer wavelength light. The combined light output can approximate a white light output. For example, a GaN-based semiconductor device generating blue light can be combined with a yellow phosphor to produce white light. Alternatively, a GaN-based semiconductor device generating ultraviolet light can be combined with red, green, and blue phosphors in a ratio and arrangement that produces white light (or another desired color). In yet another suitable embodiment, colored LEDs are used, such are phosphide-based semiconductor devices emitting red or green light, in which case the LED assembly produces light of the corresponding color. In still yet another suitable embodiment, the LED light board may include red, green, and blue LEDs distributed on the printed circuit board in a selected pattern to produce light of a selected color using a red-green-blue (RGB) color composition arrangement. In this latter exemplary embodiment, the LED light board can be configured to emit a selectable color by selective operation of the red, green, and blue LEDs at selected optical intensities. Clusters of different kinds and colors of LED is also contemplated to obtain the benefits of blending their output.

While certain embodiments have been described herein, it will be understood by one skilled in the art that the methods, systems, and apparatus of the present disclosure may be embodied in other specific forms without departing from the spirit thereof. For example, while aspects and embodiments herein have been described in the context of certain applications, the present disclosure is not limited to such.

Accordingly, the embodiments described herein, and as claimed in the attached claims, are to be considered in all respects as illustrative of the present disclosure and not restrictive.

What is claimed is:

1. A luminaire comprising:
a housing containing a driver;
a wing extending from the housing and defining an aperture;
a lighting element mount, the lighting element mount comprising:
a face defining two opposing edges; and
a wing extending from each opposing edge;
a lighting element mounted to the face of the lighting element mount;
the lighting element mount associated with the wing such that the lighting element is aligned over the wing apertures.

2. The luminaire of claim 1, the housing defining one or more slots and the wing having one or more tabs associated with the one or more slots of the housing.

3. The luminaire of claim 1, the wing having a flat mounting plate in which the apertures are defined, and a lens flange extending downward from the mounting plate, the lens flange then directed inward toward the housing such that the mounting plate and the lens flange together define a channel open toward the housing, and a lens residing in the channel.

4. The luminaire of claim 1, the face and wings of the lighting element mount defining a U-shape.

5. The luminaire of claim 1, the lighting element thermally connected to the lighting element mount face and the wings of the lighting element mount exposed to ambient air to facilitate heat dissipation.

6. The luminaire of claim 1, a mounting tab extending from the end of the lighting element mount face, the mounting tab secured to the wing adjacent to the aperture.

7. The luminaire of claim 1, wherein the lighting element comprises one or more LEDs.

8. The luminaire of claim 1, wherein the lighting element comprises a PCB populated with one or more LEDs.

9. The luminaire of claim 1, wherein two lighting element mounts are secured to the wing.

10. A luminaire comprising:
a housing comprising a base, a first leg extending from one edge of the base and a second leg extending from an opposing edge of the base, the housing defining a U-shape;
a first wing extending from the housing and defining a first aperture;
a first lighting element mount, the first lighting element mount comprising:
a face defining two opposing edges; and
a wing extending from each opposing edge;
a first lighting element mounted to the face of the first lighting element mount;
the first lighting element mount associated with the first wing such that the lighting element is aligned over first the wing apertures
a second wing extending from the housing on a side opposing the first wing, the second wing defining a second aperture;
a second lighting element mount, the second lighting element mount comprising:
a face defining two opposing edges; and
a wing extending from each opposing edge;
a second lighting element mounted to the face of the second lighting element mount;
the second lighting element mount associated with the second wing such that the lighting element is aligned over second the wing apertures; and
a driver for delivering power to the first and second lighting elements, the driver located in the U-shaped housing.

11. The luminaire of claim 10, the housing defining a plurality of slots and the first wing having one or more tabs associated with one or more of the plurality of slots of the housing; the second wing having one or more tabs associated one or more of the plurality of slots of the housing.

12. The luminaire of claim 10, the first wing having a flat mounting plate in which the first aperture is defined, and a lens flange extending downward from the mounting plate, the lens flange then directed inward toward the housing such that the mounting plate and the lens flange together define a channel open toward the housing, and a lens residing in the channel.

13. The luminaire of claim 10, the face and wings of the first lighting element mount defining a U-shape.

14. The luminaire of claim 10, the first lighting element thermally connected to the first lighting element mount face and the wings of the first lighting element mount exposed to ambient air to facilitate heat dissipation.

15. The luminaire of claim 10, a mounting tab extending from the end of the first lighting element mount face, the mounting tab secured to the first wing adjacent to the aperture.

16. The luminaire of claim 10, wherein the first lighting element comprises one or more LEDs.

17. The luminaire of claim 10, wherein the first lighting element comprises a PCB populated with one or more LEDs.

18. A luminaire comprising:
a housing containing a driver;
a mounting plate defining an aperture;
a lighting element mount, the lighting element mount comprising:
a face defining two opposing edges;
a wing extending from each opposing edge; and
a mounting tab extending from the end of the first lighting element mount face;
a lighting element mounted to the face of the lighting element mount; and
the mounting tab secured to the mounting plate adjacent to the aperture such that the lighting element is aligned over the wing apertures.

19. The luminaire of claim 18, the face and wings of the first lighting element mount defining a U-shape.

20. The luminaire of claim 18, the lighting element thermally connected to the first lighting element mount face and the wings of the first lighting element mount exposed to ambient air to facilitate heat dissipation.

21. The luminaire of claim 18, wherein the lighting element comprises one or more LEDs.

22. The luminaire of claim 18, wherein the lighting element comprises a PCB populated with one or more LEDs.
